(19) United States
(12) Patent Application Publication
(10) Pub. No.: US 2024/0053026 A1
(43) Pub. Date: Feb. 15, 2024

(54) ELECTRIC RANGE

(71) Applicant: LG ELECTRONICS INC., Seoul (KR)

(72) Inventors: Seunghak KIM, Seoul (KR); Junghyeon Cho, Seoul (KR)

(21) Appl. No.: 18/221,441

(22) Filed: Jul. 13, 2023

(30) Foreign Application Priority Data
Aug. 12, 2022 (KR) 10-2022-0101161

(51) Int. Cl. F24C 15/10; F24C 7/08

(52) U.S. Cl. CPC F24C 15/101; F24C 7/081

(57) ABSTRACT

An electric range may include a case, a bracket accommodated in the case, a fan disposed in the bracket, a leg coupled to a lower portion of the case and configured to contact an upper surface of a countertop that supports the electric range, and a guide panel disposed at a lower side of the bracket and configured to guide air that flows in a gap formed by the leg.

### CROSS-REFERENCE TO RELATED APPLICATION(S)

This application claims priority to and benefit of Korean Patent Application No. 10-2022-0101161, filed in Korea on Aug. 12, 2022, which is hereby incorporated by reference as if fully set forth herein.

### BACKGROUND

### 1. Field

An electric range, and in particular, an electric range having structure capable of blocking the inflow of moisture is disclosed herein.

### 2. Background

Details in the background section do not constitute a prior art but are given only as background information concerning the subject matter disclosed herein.

Various types of cooking appliances are used to heat a food item or other items (hereinafter collectively “food”) at homes or restaurants. Cooking appliances include gas ranges using gas and electric ranges using electricity.

Electric ranges are classified as resistance heating-type electric ranges and induction heating-type electric ranges. When it comes to electrical resistance heating, electric current is supplied to a metallic resistance wire or a non-metallic heat generating element, such as silicon carbide, to generate heat, and the generated heat is radiated or conducted to heat a heating target, for example, a cooking container, such as a pot, or a frying pan, for example. When it comes to induction heating, high-frequency power is supplied to a coil to generate a magnetic field around the coil, and eddy current produced in the generated magnetic field is used to heat a heating target made of a metallic material.

In basic heating theories of induction heating, when electric current is supplied to a working coil or a heating coil, heat is generated while a heating target is heated based on induction heating, and the heating target is heated by the generated heat.

Home appliances may be adjacent to one another such that they can be installed and used conveniently. For example, an electric range and a dishwasher may be disposed in the same position. The dishwasher of a relatively large volume may be disposed under the electric range, and the electric range of a relatively small volume may be disposed on the dishwasher.

In the case of a dishwasher, doors may be opened to dry tableware accommodated therein, and moisture in the dishwasher may be discharged outward. The moisture discharged from the dishwasher may flow into an electric range disposed on the dishwasher.

An electric cooking appliance is disclosed in U.S. Pat. No. 4,216,370 (hereinafter, “Related Art 1”), which is hereby incorporated by reference. Related Art 1 does not suggest structure that blocks moisture from flowing into the electric cooking appliance through a lower portion of the electric cooking appliance. In the air communication hole the electric cooking appliance according to Related Art 1 is disposed right on a dishwasher, moisture discharged from the dishwasher may flow into the electric cooking appliance through the lower portion of the electric cooking appliance, affecting components in the electric cooking appliance adversely, and causing deterioration in the performance of the electric cooking appliance.

Additionally, a heating device is disclosed in U.S. Pat. No. 9,775,197 (hereinafter, “Related Art 2”), which is hereby incorporated by reference. Related Art 2 suggests that a shielding structure that blocks a reverse flow of air is disposed near an opening of an air passage, to protect a heating unit from reversely flowing hot air. The shielding structure suppresses the flow of air discharged out of the heating device into the heating device, but moisture outside of the heating device is likely to flow into the heating device through the opening of the air passage. Like Related Art 1, Related Art 2 cannot solve the above-described problem.

Further, a printed circuit board that operates an electric range may be disposed in an electric range, and an element that generates heat at a time of supply of electricity may be mounted on the printed circuit board. To cool the heat generating element, the electric range may be provided with a heat sink on which a heat generating element is mounted, an air guide which covers the heat sink and forms a flow path of air cooling the heat sink, and an air blowing fan that forces air to flow to the air guide.

In the structure, the electric range can have an air inlet and an air outlet. Air discharged out of the electric range through the outlet is heated while passing through the heat sink, and is hotter than air flowing through the inlet.

The hot air discharged through the outlet may flow into the air flowing fan again through the inlet without being scattered to surroundings. The hot air may keep circulating and flowing in the heat sink.

The circulatory flow causes the heat generating element mounted on the heat sink to be easily heated by the hot air circulating and flowing. A controller of the electric range stops operating the electric range at a predetermined temperature or greater, to protect the heat generating element.

If the heat generating element is easily heated by the circulatory flow of the hot air, a temperature of the heat generating element reaches a predetermined temperature or greater rapidly within a short period of time, causing a reduction in operation time of the electric range and frequent stopping of the operation of the electric range. Thus, a performance of the electric range may deteriorate. Against this backdrop, structure for suppressing or preventing circulation and flow of hot air around the heat sink is required.

### BRIEF DESCRIPTION OF THE DRAWINGS

Embodiments will be described in detail with reference to the following drawings in which like reference numerals refer to like elements, and wherein:

FIG. 1 is a perspective view of an electric range is disposed at an upper side of a dishwasher according to an embodiment;

FIG. 2 is a side view of the dishwasher of FIG. 1;

FIG. 3 is a perspective view of an electric range according to an embodiment;

FIG. 4 is a side view of the electric range of FIG. 3;

FIG. 5 is a bottom perspective view of the electric range of FIG. 3;

FIG. 6 is an enlarged view showing portion A of the electric range of FIG. 5;

FIG. 7 is an exploded perspective view of the electric range according to an embodiment;

FIG. 8 is a perspective view of an air guide separated from a bracket;

FIG. 9 is a bottom view of the bracket, viewed upward from below;

FIG. 10 is a bottom perspective view showing components of the electric range according to an embodiment;

FIG. 11 is a perspective view of a guide panel according to an embodiment;

FIG. 12 is a side view of the guide panel of FIG. 11;

FIG. 13 is a bottom view showing part of a case, viewed upward from below;

FIG. 14 is a view of a guide panel coupled to the case shown in FIG. 13;

FIG. 15 is a lateral cross-sectional view of the electric range according to an embodiment;

FIG. 16 is an enlarged view showing a rear of the electric range shown in FIG. 15;

FIG. 17 is an enlarged view showing a front of the electric range shown in FIG. 15;

FIG. 18 is a view showing a heat sink for a simulation evaluation;

FIGS. 19 to 22 are views showing results of computer simulation-based evaluation of heat distribution of air flowing in an electric range according to an embodiment; and

FIG. 23 is a view showing results of computer simulation-based evaluation of a flow tendency of air in an electric range according to an embodiment.

### DETAILED DESCRIPTION

Aspects, features, and advantages are specifically described hereafter with reference to the accompanying drawings such that one having ordinary skill in the art to which embodiments pertain can embody the technical spirit easily. Hereinafter, description of known technologies in relation to the subject matter is omitted if it is deemed to make the gist unnecessarily vague. Hereafter, embodiments are specifically described with reference to the accompanying drawings. In the drawings, identical reference numerals can denote identical or similar components.

The terms “first”, and “second”, for example, are used herein only to distinguish one component from another component. Thus, the components should not be limited by the terms. Certainly, a first component can be a second component, unless stated to the contrary.

Hereinafter, each component can be provided as a single one or a plurality of ones, unless explicitly stated to the contrary.

The singular forms “a”, “an” and “the” are intended to include the plural forms as well, unless explicitly indicated otherwise. It is to be further understood that the terms “comprise” or “include” and the like, set forth herein, are not interpreted as necessarily including all the stated components or steps but can be interpreted as excluding some of the stated components or steps or can be interpreted as including additional components or steps.

Hereinafter, the terms “A and/or B” as used herein can denote A, B or A and B, and the terms “C to D” can denote C or greater and D or less, unless stated to the contrary.

Hereinafter, an “upward-downward direction” denotes the upward-downward direction of an electric range that is normally installed for use. A “leftward-rightward direction” denotes a direction orthogonal to the upward-downward direction, a “frontward-rearward direction” denotes a direction orthogonal to both the upward-downward direction and the leftward-rightward direction, and “both lateral directions” or a “lateral direction” have the same meaning as the leftward-rightward direction. The above-mentioned terms can be used in a mixed manner.

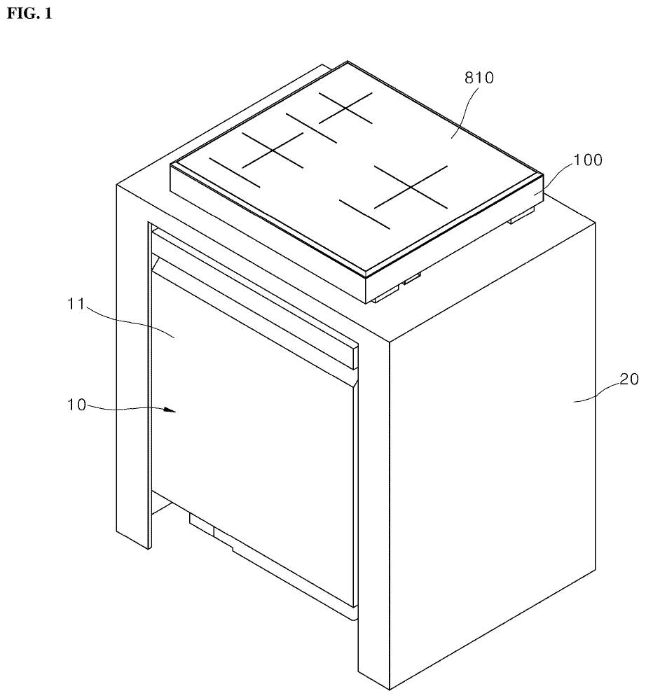

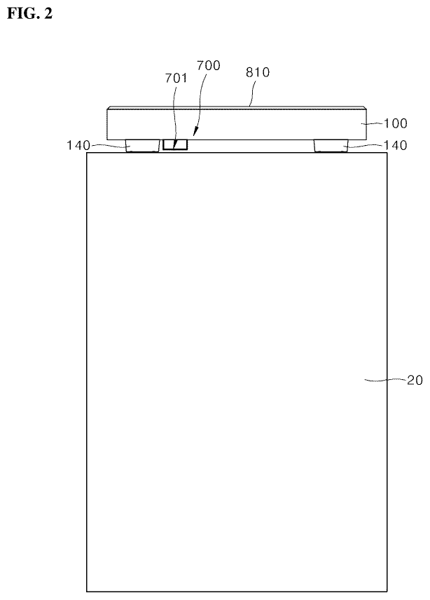

FIG. 1 is a perspective view of an electric range according to an embodiment disposed at an upper side of a dishwasher. FIG. 2 is a side view of the dishwasher of FIG. 1.

The electric range cooks a food item or other items (hereinafter collectively “food”), and the dishwasher washes tableware used for containing food. The electric range and dishwasher 10 are closely relate to each other, and both may be placed on kitchen countertops.

As the dishwasher 10 has a relatively large volume, the dishwasher 10 may be usually built into a kitchen countertop where food is cooked and tableware washed, to ensure spatial availability. In FIG. 1, the dishwasher 10 may be stored and built in a countertop 20 that has a storage space, has an upper surface on which the electric range is placed, and supports the electric range, in the kitchen. The countertop 20 may be part of kitchen countertops.

A space may be formed at an upper side of the dishwasher 10. To use the space, the electric range may be disposed at the upper side of the dishwasher 10. Accordingly, the electric range may be disposed on the upper surface of the countertop 20 in which the dishwasher 10 is stored. The electric range according to this embodiment may be disposed at the upper side of the dishwasher 10, and the electric range and the dishwasher 10 may be disposed in the same space.

The dishwasher 10 may dry wash water that remains on a surface of tableware accommodated in the dishwasher 10, after washing the tableware with wash water. To dry tableware, heated air is discharged to a tableware storage space of the dishwasher 10, and wash water on the surface of the tableware may be evaporated by the heater air. The evaporated wash water may form moisture in the tableware storage space.

To discharge the moisture to the outside, a door 11 may be opened. The door 11 of the dishwasher 10 may hinge-rotate to open and close the tableware storage space. The door 11 rotates around a lower portion of the dishwasher 10. Thus, as the door 11 is opened, the upper portion of the dishwasher 10 may be opened first.

While the tableware is dried, the door 11 may be rotated by about 5° in a closed position, to open the upper portion of the dishwasher 10. Accordingly, through an open gap, the moisture may be discharged out of the dishwasher 10.

The moisture discharged out of the dishwasher 10 may approach the electric range disposed at the upper side of the dishwasher 10. The moisture is likely to approach to and flow into the electric range.

The door 11 is disposed at the front of the dishwasher 10. The moisture discharged though the open gap of the door 11 may move upward and flow into the electric range through a gap in a lower portion of a front part or portion of the electric range.

To suppress or prevent flow of the moisture into the electric range, in the lower portion of the front part of the electric range, the electric range according to this embodiment may be provided with a guide panel 700. Hereafter, structure of the electric range is described with reference to the drawings.

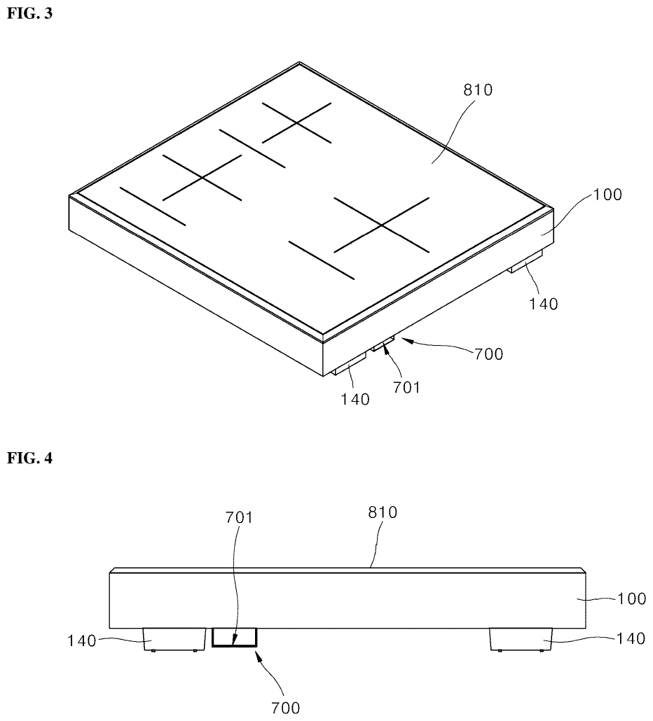

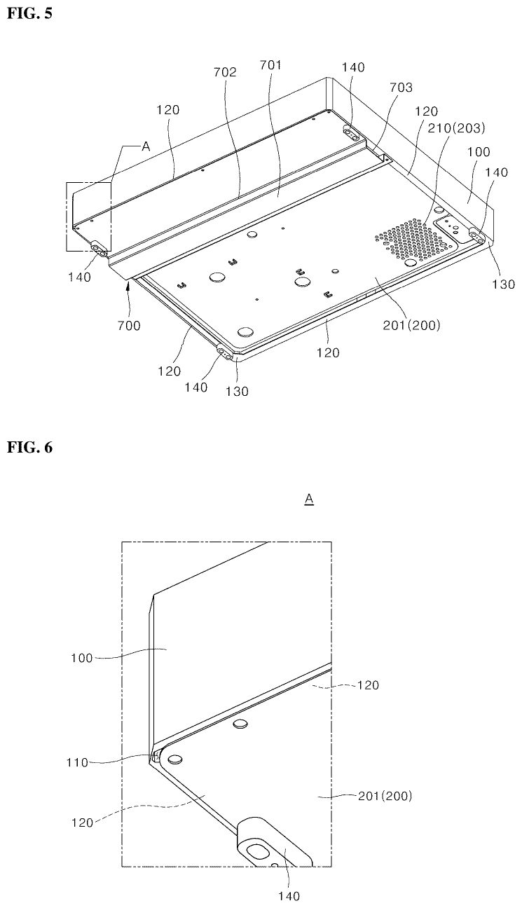

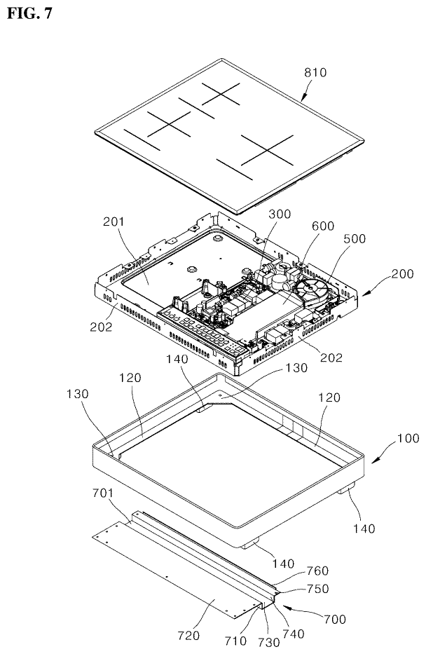

FIG. 3 is a perspective view of an electric range according to an embodiment. FIG. 4 is a side view of the electric range of FIG. 3. FIG. 5 is a bottom perspective view of the electric range of FIG. 3. FIG. 6 is an enlarged view showing portion A of the electric range of FIG. 5. FIG. 7 is an exploded perspective view of the electric range according to an embodiment.

The electric range according to this embodiment may heat a heating target, based on induction heating. The heating target may be tableware that contains a metallic material, such as stainless steel, or iron, for example.

In the induction heating method, high-frequency power is supplied to a working coil to generate a magnetic field around the working coil, and eddy current generated by the generated magnetic field is used to heat a heating target made of a metallic material.

That is, applying high-frequency power to the working coil of heating unit 820 to generate a magnetic field around the working coil, and in a case in which a heating target is placed in an area of the generated magnetic field, the magnetic field induces eddy current in the heating target, and Joule's heat is generated by the eddy current, to heat the heating target. As tableware, that is, a heating target is heated, food contained in the heating target may be heated and cooked.

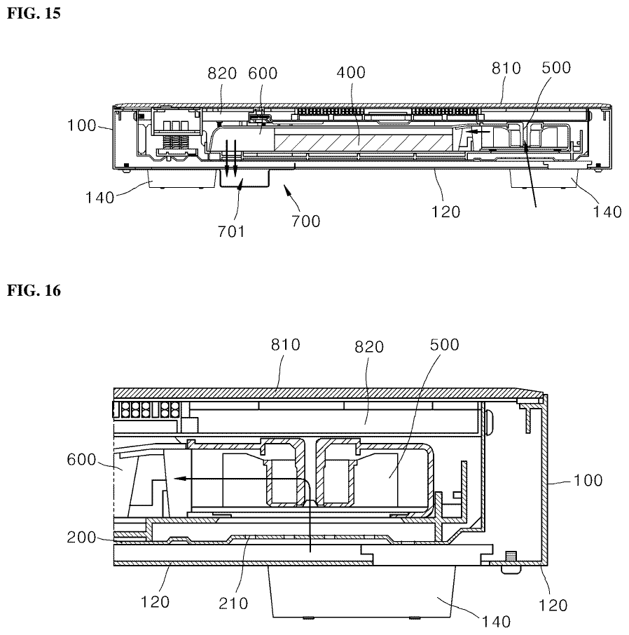

The electric range may include a case 100, a cover plate 810, and the heating unit 820 (see FIG. 15). The case 100 may protect components constituting the electric range. For example, the case 100 may be made of aluminum; however, embodiments are not limited thereto. Additionally, the case 100 may be thermally insulated to suppress or prevent discharge of heat, generated by a working coil of the heating unit 820, to the outside.

Components such as heating unit 820, a working coil, a bracket 200, and a control board, for example, constituting the electric range, may be stored in the case 100, and an upper portion and a lower portion of the case 100 may be open. The upper portion of the case 100 is open, but the open portion may be closed by the cover plate 810. The case 100 may be generally formed in such a way that a sheet-shaped material is processed in the form of a box.

The cover plate 810 may be coupled to an upper end of the case 100, and a heating target may be disposed on an upper surface of the cover plate 810. The cover plate 810 may close the open upper portion of the case 100 and protect components stored in the case 100.

A heating target is placed on the upper surface of the cover plate 810, and a magnetic field generated in the heating unit 820 may pass through the cover plate 810 and reach the heating target. The cover plate 810, for example, may be made of a material comprising ceramics; however, embodiments are not limited thereto.

An input interface may be disposed on the upper surface of the cover plate 810, and provided with an input of the user. The input interface may be disposed in a specific area of the upper surface of the cover plate 810, and display a specific image.

The input interface may receive a touch input from the user, and the electric range may operate based on the touch input received. The input interface, for example, may be a module for inputting heating intensity or heating time, for example, desired by the user, and may be embodied as a physical button or a touch panel, for example. For example, the input interface may be a thin film transistor liquid crystal display (TFT LCD); however, embodiments are not limited thereto.

Additionally, a plurality of heating units 820 may be provided, disposed under the cover plate 810, and heat a heating target. In this embodiment, the heating unit 820 may be based on induction heating.

As another example, some of the plurality of heating units 820 may be based on induction heating, and the rest of the heating units 820 may be embodied as highlight heating devices based on electrical resistance heating. Accordingly, the electric range may be embodied as a hybrid range.

Hereafter, an electric range in which a plurality of heating units 820 is all based on induction heating is described.

The heating unit 820 may be provided with a core frame, and a working coil may be wound spirally on an upper surface of the core frame, and a ferrite core may be mounted on a lower surface of the core frame. Accordingly, as high-frequency power is supplied to the working coil, a magnetic field may be generated around the ferrite core, and the formed magnetic field may form eddy current in a heating target.

The electric range may further include the bracket 200, and a printed circuit board 300. The bracket 200 may be accommodated in the case 100, the printed circuit board 300 may be mounted on the bracket 200, and the bracket 200 may include a bottom plate 201 and a side pate 202. The bottom plate 201 may form a bottom surface of the bracket 200, and the printed circuit board 300 may be mounted on an upper surface of the bottom plate 201.

The side plate 202 may be formed in such a way that the side plate 202 is bent from the bottom plate 201 in the upward-downward direction of the electric range. The side plate 202 may be formed in such a way that the side plate 202 is bent from an edge of the bottom plate 201 in the upward-downward direction.

The side plate 202 may be disposed at each side of the bottom plate 201 which is entirely formed into a rectangle. In a case in which a plurality of upper brackets 200 is provided, the side plate 202 may be formed at each side of the bottom plate 201, except for a side at which an upper bracket 200 and an upper bracket 200 are adjacent to each other.

The side plate 202 may help to improve rigidity of the entire bracket 200. That is, the side plate 202 bent from the bottom plate 201 may suppress or prevent the bending or damage to the plate-shaped bottom plate 20, which is caused by a weight of the components built into a circuit board, for example, or an external force.

The bracket 200 may be made of a plastic material that is easily manufactured, is lightweight, and is readily injection-molded and electrically insulated to ensure electric insulation; however, embodiments are not limited thereto.

The printed circuit board 300 may be disposed in the bracket 200. The printed circuit board 300 may constitute a controller that controls an operation of the electric range, and receives power from an external power source. A heat sink 400 may be mounted on the printed circuit board 300, and various types of active components and passive components for operating the electric range may be mounted on the printed circuit board 300, and an electric circuit may be formed on the printed circuit board 300.

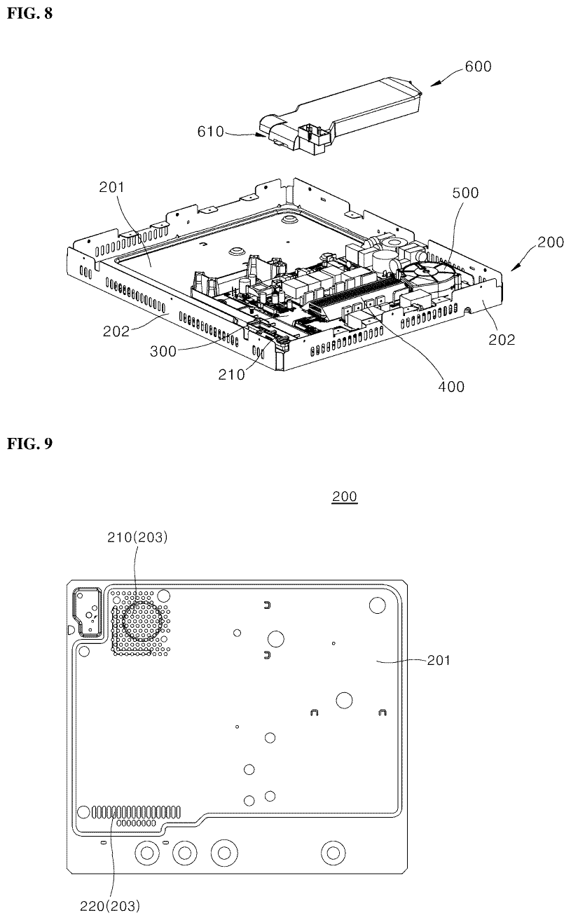

FIG. 8 is a perspective view of an air guide separated from the bracket 200. The electric range according to this embodiment may further include the heat sink 400, an air blowing fan (fan) 500 and an air guide 600. Further, an element that generates a large amount of heat at a time when the electric range operates may be mounted on the printed circuit board 300.

For example, in the electric range, elements in charge of on-off control of the heating unit 820 generate large amounts of heats. To suppress or prevent an operation stop or failure of the electric range, caused by overheating of the elements, the elements need to be forcibly cooled.

To forcibly cool the elements of the printed circuit board 300, the electric range according to this embodiment may be provided with the heat sink 400, the air blowing fan 500, and the air guide 600. Hereinafter, the elements that generate large amounts of heat and need to be forcibly cool are referred to as “heat generating elements”.

The heat sink 400 may be mounted on the printed circuit board 300. The heat sink 400 cools the inside of the case 100 to protect the components accommodated in the case 100. The heat sink 400 may be mounted on the printed circuit board 300 and cool the circuit board. Further, the heat sink 400 may keep the heating unit 820 cool from heat that is caused by electromagnetic interaction as the heating unit 820 operates.

For example, a plurality of cooling pins may be formed at the heat sink 400. The air guide 600 may be provided to cover the cooling pins and guide air to the cooling pins.

The air blowing fan 500 may be disposed in the bracket 200, and allow air to flow to the heat sink 400. The air blowing fan 500 may be mounted on the bracket 200, and provided to discharge air to the heat sink 400. The air blowing fan 500 may be electrically connected to the printed circuit board 300, and operation of the air blowing fan 500 may be controlled by a controller provided on the printed circuit board 300.

As the air blowing fan 500 operates, air in the case 100 is forced to flow to the heat sink 400, and the flowing air may cool the heat sink 400. The heat sink 400 may cool the elements mounted on the surface of the heat sink 400, the printed circuit board 300, and the inside of the case 100.

The air guide 600 may be provided to communicate with the air blowing fan 500 and to surround the heat sink 400, and form a flow path of air cooling the heat sink 400. The air guide 600, for example, may be made of a plastic material that is easily injection-molded and exhibits electric insulation; however, embodiments are not limited thereto.

The air guide 600 may change a flow direction of air. That is, the air guide 600 may be formed to allow air to flow in the frontward-rearward direction of the electric range at an inlet of the air guide 600, and to allow air to flow in the upward-downward direction of the electric range at an outlet of the air guide 600. With this structure, air discharged from the air blowing fan 500 may flow into the air guide 600 in the frontward-rearward direction of the electric range, and escape from the air guide 600 in a direction of a lower side of the electric range.

Additionally, the air guide 600 may be detachably coupled to the bracket 200. For example, a rear of the air guide 600, adjacent to the air blowing fan 500, may be coupled to the bracket 200 by a coupling tool, such as a screw bolt, for example. Further, the front of the air guide 600, from which air is discharged, may be shape-fitted to the bracket 200, for example.

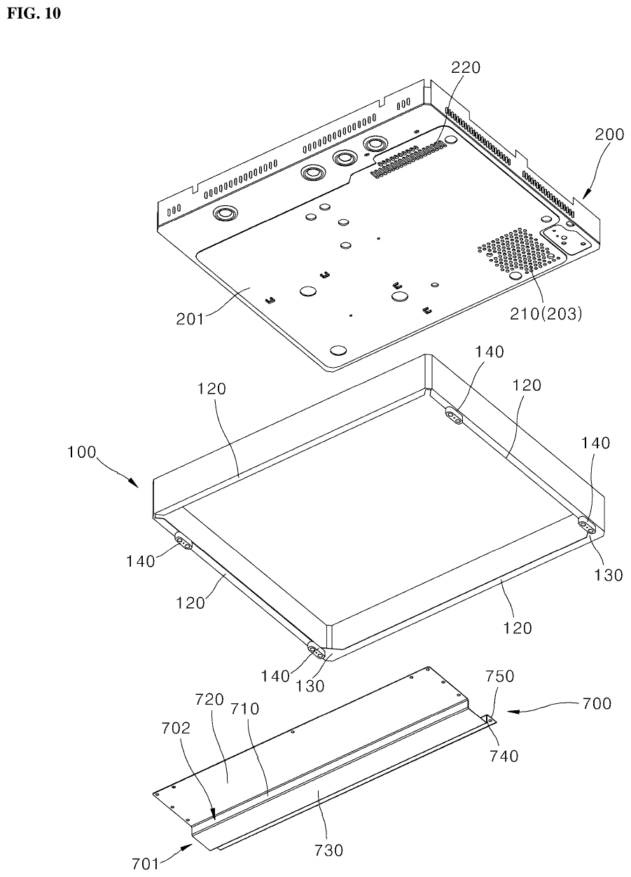

FIG. 9 is a bottom view of that the bracket, viewed upward from below. FIG. 10 is a bottom perspective view showing components of the electric range according to an embodiment. The electric range may further include a guide panel 700.

The guide panel 700 may be disposed at the lower side of the bracket 200, and have a channel part or portion (channel) 701 in a position corresponding to the outlet of the air guide 600. The channel part 701 may guide the flow of air. The channel part 701 of the guide panel 700 may be provided in the lower portion of the front part or portion of the electric range, and protrude in the direction of the lower side of the electric range.

With this structure, moisture approaching to the lower portion of the front of the electric range from the door 11 of the dishwasher 10 may be blocked from coming into the electric range. Additionally, the channel part 701 guides hot air discharged from the front part of the dishwasher in both lateral directions of the electric range, and blocks the hot air from flowing into the air blowing fan 500 again, such that the hot air is blocked from circulating and flowing at the front part of the dishwasher.

The case 100 may include a penetration hole 110, a coupling part or portion 120, a bridge 130, and a leg 140. The coupling part 120 may be formed in such a way that the coupling part 120 is bent from the lower end of the case 100. The coupling part 120 may be formed at each side of a rectangle that forms the case 100. The guide panel 700, the bridge 130, and the leg 140 may be coupled to a flat surface that is formed by the coupling part 120.

The bridge 130 may be coupled to the coupling part 120, at the lower end of the case 100. The bridge 130 may be coupled to the coupling part 120 in such a way that the bridge 130 is adjacent to the side of the rear part of the case 100, to which the guide panel 700 is not coupled, among four sides of the case 100.

The bridge 130 may be coupled respectively to the coupling part 120 where both end portions of the sides of the case 100 are adjacent to each other, at a lower end edge of the case 100. As the bridge 130 is coupled to the coupling part 120, the bridge 130 may help to improve the rigidity of the case 100 that is entirely formed into a thin plate. Accordingly, deformation of the case 100, caused by an external force, may be suppressed or prevented. As another example, the bridge 130 may be integrated with the coupling part 120.

Additionally, the rigidity of the case 100 may be improved by the guide panel 700, at the edge of the front part of the case 100 to which the guide panel 700 is coupled. Accordingly, the bridge 130 may not be provided at the edge of the front part of the case 100.

The leg 140 may be coupled to the lower portion of the case 100 and protrude further downward than the lower surface of the case 100, and contact the upper surface of the countertop 20 that supports the electric range. The leg 140 may be coupled to the lower surface of the coupling part 120 and support the electric range. As the leg 140 protrudes in the downward direction of the electric range, a space may be formed between the lower surface of the case 100 and the upper surface of the countertop 20. In the space, the channel part 701 of the guide panel 700 protruding in the downward direction of the electric range may be disposed, without interfering with the countertop 20.

Additionally, the leg 140 and the channel part 701 may be spaced from each other in the frontward-rearward direction of the case 100. Thus, the leg 140 and the channel part 701 may not interfere with each other.

The guide panel 700 may be disposed at the lower side of the bracket 200, and guide air flowing in a gap that is formed by the leg 140. For example, moisture flowing into the gap that is formed between the lower surface of the case 100 and the upper surface of the countertop 20 by the leg 140 may be blocked from flowing into the electric range by the channel part 701 formed at the guide panel.

Part of the leg 140 may be coupled to the guide panel 700. Accordingly, in a case in which the leg 140 is disposed at a portion at which the guide panel 700 is mounted, the guide panel 700 is disposed on the leg 140, and the coupling part 120 may be disposed on the guide panel 140. The leg 140, the guide panel 700, and the coupling part 120 may be coupled stably by a coupling tool, such as a bolt, for example, that penetrates the leg 140, the guide panel 700, and the coupling part 120.

The penetration hole 110 is described with reference to FIG. 6. The penetration hole 110 may be formed at an edge where the guide panel 700 is disposed, among lower edges of the case 100. Accordingly, the penetration hole 110 may be formed at two edges, out of a total of four edges of the case 100.

The penetration hole 110 may be formed as a gap is formed between the guide panel 700 and the case 100 because of a difference between a radius of curvature at the edge of the case 100 and a radius of curvature at the edge of the guide panel 700, in a case in which the guide panel 700 is coupled to the case 100.

As the penetration hole 110 is disposed in the lower portion of the front part of the electric range, there is a possibility that hot air discharged from the electric range flows into the electric range through the penetration hole 110. To eliminate the possibility, shapes of the edges of the case 100 or the guide panel 700 are processed to correspond to one another not to form the penetration hole 110, or the penetration hole 110 may be blocked by an additional component. However, additional design incurs costs of manufacturing.

Based on results of simulation described hereafter, there is almost no difference between the performance of the electric range with the penetration hole 110 and the performance of the electric range without the penetration hole 110. This indicates that hot air discharged from the electric range through the penetration hole 110 hardly flows back into the electric range.

That is, the penetration hole 110 has almost no effect on the performance of the electric range. Accordingly, there is no need to incur additional manufacturing costs, and the penetration hole 110 does not need to be blocked. The results of the simulation are described hereinafter.

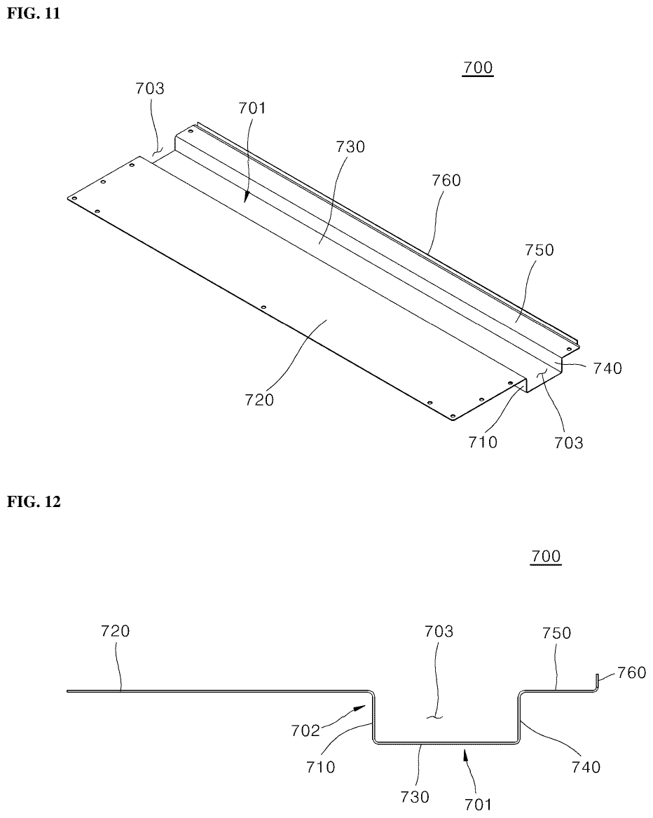

Hereinafter, the guide panel 700 is specifically described with reference to the drawings. FIG. 11 is a perspective view of a guide panel according to an embodiment. FIG. 12 is a side view of the guide panel of FIG. 11.

The guide panel 700, for example, may be manufactured in such a way that a relatively thin metallic plate is bent based on a rolling process, for example. The guide panel 700 may include first panel 710 and second panel 720.

The first panel 710 may be elongated in the downward direction of the case 100, and may form a space in which air flows, together with third panel 730 and fourth panel 740 that are described hereafter. The first panel 710 may form a front surface of the channel part 701.

The first panel 710 may block the gap that is formed by the leg 140, at the lower side of the electric range. Accordingly, moisture that approaches to the electric range through the gap may be blocked by the first panel 710 and blocked from flowing into the electric range.

The first panel 710, the third panel 730, and the fourth panel 740 may form the channel part 701 that has an entirely rectangular shaped-cross section. The structure where the first panel 710, the third panel 730, and the fourth panel 740 are coupled protrudes from the lower portion of the electric range, and hot air discharged from the air guide 600 may flow to the channel part 701 which is a space formed by the first panel 710, the third panel 730, and the fourth panel 740.

The second panel 720 may be bent from an end portion of the first panel 730, and be coupled to the lower surface of the case 100. The second panel 720 may be coupled to the coupling part 120 that is formed on the lower surface of the case 100. The second panel 720 may be coupled to the lower surface of the case 100 and close an open lower portion of the front part of the case 100.

The guide panel 700 may further include the third panel 730, the fourth panel 740, and fifth panel 750. The third panel 730 may bent from the first panel 710 and form a bottom surface of the channel part 701. As the guide panel 700 is mounted in the case 100, the third panel 730 may be disposed in a lowermost portion of the guide panel 700.

The fourth panel 740 may be bent from an end portion of the third panel 730 and be spaced from the first panel 710. The fourth panel 740 may be elongated from an end portion of the third panel 730, and form a rear surface of the channel part 701. The fourth panel 740 may form the channel part 701, together with the first panel 710 and the third panel 730.

The fifth panel 750 and the second panel 720 may be spaced from each other with the channel part 701 therebetween, bent from an end portion of the fourth panel 740 and be coupled to the lower surface of the case 100. The fifth panel 750 may be coupled to the coupling part 120 that is formed on the lower surface of the case 100.

Lengthwise directions of the first panel 710 to the fifth panel 750 may extend in both lateral directions of the case 100. Accordingly, a lengthwise direction of the channel part 701 formed by the first panel 710, the third panel 730, and the fourth panel 740 may extend in both lateral directions of the case 100. Accordingly, hot air flowing into the channel part 701 may flow in both lateral directions of the case 100.

Additionally, the second panel 720 and the fifth panel 750 may be elongated in both lateral directions of the case 100, and both lateral end portions of the second panel 720 and the fifth panel 750 may be coupled to a pair of coupling parts 120 that face each other, and may close the open lower portion of the front part of the case 100.

The second panel 720 may be disposed at the front of the channel part 701, and the fifth panel 750 may be disposed at the rear of the channel part 701. The second panel 720 may be disposed at the front of the channel part 701, and block moisture that is discharged from the dishwasher 10 and flows to the lower portion of the front part of the case 100 from flowing into the electric range.

The first panel 710 and the fourth panel 740 may be formed in such a way that the first panel 710 and the fourth panel 740 are bent from both ends of the third panel 730. The second panel 720 may be elongated from the end portion of the first panel 710 that is formed at the front of the channel part 701, and the fifth panel 750 may be elongated from the end portion of the fourth panel 740 that is formed at the rear of the channel part 701.

The first panel 710 and the second panel 720 have shapes that are entirely symmetrical to those of the fourth panel 740 and the fifth panel 750, with respect to the third panel 730, and a frontward-rearward width of the second panel 720 may be greater than a frontward-rearward width of the fifth panel 750.

As described above, the second panel 720 may have a length that is sufficiently elongated in the frontward-rearward direction, and may be disposed in the lower portion of the front part of the case 100 and close the open portion of the case 100, such that moisture toward the lower portion of the front part of the case 100 is effectively blocked from flowing into the electric range. The first panel 710 may be elongated from one or a first end of the third panel 730, and form a front surface of the channel part 701. The fourth panel 740 may be elongated from the other or a second end of the third panel 730 and form a rear surface of the channel part 701.

The first panel 710 and the fourth panel 740 may be disposed in such a way that widthwise directions of the first panel 710 and the fourth panel 740 are parallel with the case 100 in the upward-downward direction. Accordingly, the first panel 710 and the fourth panel 740 may be coupled to the third panel 730 and formed to protrude in the downward direction of the electric range. That is, the first panel 710 and the fourth panel 740 may form the channel part 701 that guides hot air discharged from the air guide 600 to allow the hot air to flow in the lateral direction of the electric range, together with the first panel 710. Additionally, as the first panel 710 is disposed in such a way that the widthwise direction of the first panel 710 is placed in the upward-downward direction of the electric range, the flow direction of moisture discharged from the dishwasher 10 toward the guide panel 700 changes because the moisture is blocked by the first panel 710, thereby preventing the moisture from flowing into the electric range.

The guide panel 700 may further include sixth panel 760 bent from an end portion of the fifth panel 750 and disposed in such a way that an end of the sixth panel 760 is disposed toward the bottom plate 201 of the bracket 200. Hot air discharged from the air guide 600 may pass through the bottom plate 201 of the bracket 200 and flow to the guide panel 700 that is disposed at the lower side of the bottom plate 201. Most of the air having flown to the guide panel 700 may flow in both lateral directions of the electric range through the channel part 701, and be discharged out of the electric range through a third exhaust opening 703 that is formed at both ends of the channel part 701.

However, as bottom plate 201 of the bracket 200 and the fifth panel 740 are spaced from each other, with a space therebetween, some of the air having flown to the guide panel 700 through the space may flow to the rear of the electric range. The air flowing to the rear of the electric range may flow to the air blowing fan 500 again through a first suction opening 210 that is formed at a rear part or portion of the bottom plate 201, generating a circulatory flow of the air. The sixth panel 760 may block part of a path of air circulating and flowing to suppress or prevent re-inflow of hot air discharged from the air guide 600 to the air blowing fan 500.

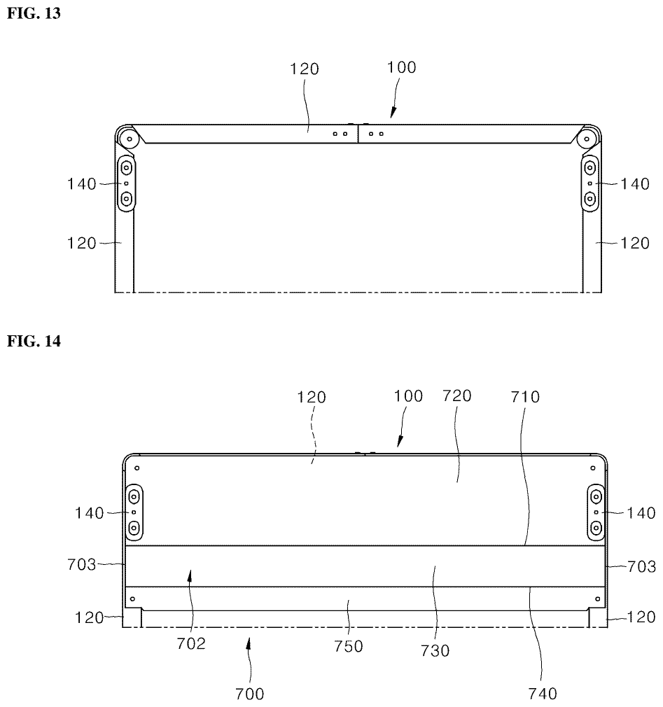

FIG. 13 is a bottom view showing part of a case, viewed upward from below. FIG. 14 is a view of a guide panel coupled to the case shown in FIG. 13.

The guide panel 700 may be detachably provided at the case 100. Depending on states of use, the guide panel 700 may be mounted on the lower surface of the case 100 or may not.

As illustrated in FIG. 13, in a case in which the guide panel 700 is not mounted on the case 100, the leg 140 may be mounted directly on the coupling part 120. Moisture flowing from the dishwasher 10 is highly likely to flow into the electric range, and hot air discharged from the air guide 600 may flow to the air flowing fan 500 again and circulate and flow in the air flowing fan 500.

As illustrated in FIG. 14, in a case in which the guide panel 700 is mounted on the case 100, the guide panel 700 may be first coupled to the coupling part 120 of the case 100, and the leg 140 may be coupled to a position of the lower surface of the guide panel 700, which corresponds to the position of the coupling part 120. The coupling part 120, the guide panel 700, and the leg 140 may be coupled reliably through a coupling tool that penetrates the coupling part 120, the guide panel 700, and the leg 140. In a case in which the guide panel 700 is provided as described above, the flow of moisture into the electric range, and the circulatory flow of discharged air may be effectively blocked, ensuring improvement in performance and durability of the electric range.

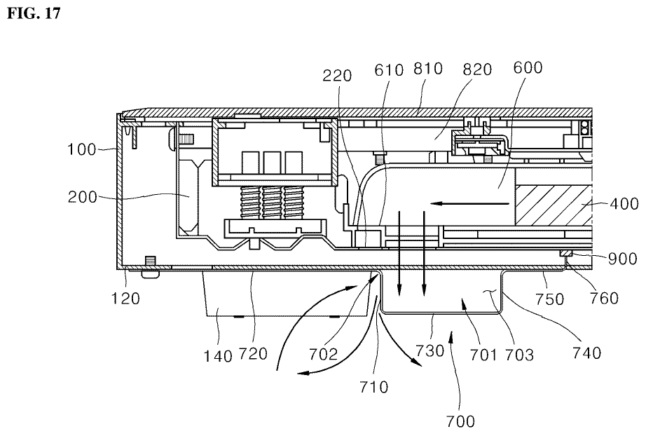

FIG. 15 is a lateral cross-sectional view of the electric range according to an embodiment. FIG. 16 is an enlarged view showing a rear of the electric range shown in FIG. 15. FIG. 17 is an enlarged view showing a front of the electric range shown in FIG. 15. In FIGS. 15 to 17, the arrows indicate flow directions of air for cooling and moisture discharged from the dishwasher 10.

To force air for cooling to flow to the heat sink 400, the bracket 200 may have an air communication hole 203 that serves as an inlet and an outlet of air. The air communication hole 203 may be provided on the bottom plate 201 of the bracket 200. The guide panel 700 may be disposed at the lower side of the air communication hole 203.

The air communication hole 203 may include first suction opening 210 and first exhaust opening 220. Air may flow into an inlet of the air blowing fan 500 through the first suction opening 210. Air having passed through the air blowing fan 500 and having flown in the air guide 600 may be discharged out of the electric range through the first exhaust opening 220.

The first suction opening 210 and the first exhaust opening 220 may be spaced from each other in the frontward-rearward directions of the bracket 200 and the case 100. Accordingly, air for cooling may flow in the frontward-rearward direction of the case 100, and a lengthwise direction of the air guide 600 guiding the flow of air may be in the frontward-rearward direction of the case 100.

The air guide 600 may include second exhaust opening 610 through which air is discharged. Accordingly, air discharged to the air blowing fan 500 may cool the heat sink 400 that is surrounded by the air guide 600 while the air passes through the air guide 600, and may be heated and flow to the channel part 701 of the guide panel 700 as hot air by passing through the second exhaust opening 610 of the air guide 600 and the first exhaust opening 220 of the bottom plate 201 consecutively.

The channel part 701 may be disposed in a position at which at least a part or portion of the channel part 701 overlaps the first exhaust opening 220. Additionally, the channel part 701 may be disposed in a position at which at least a part or portion of the channel part 701 overlaps the second exhaust opening 610.

The channel part 701 may be disposed in the upward-downward direction of the electric range, in a position at which the channel part 701 overlaps the first exhaust opening 220 of the bottom plate 201 and the second exhaust opening 601 of the air guide 600. With this structure, hot air discharged from the second exhaust opening 610 of the air guide 600 may smoothly pass through the second exhaust opening 610 and the first exhaust opening 220 consecutively and flow into the channel part 701.

The lengthwise direction of the channel part 701 may be formed in both lateral directions of the case 100, and the third exhaust opening 703 through which air is discharged may be formed at both ends of the channel part 701. Accordingly, hot air may flow in the downward direction of the electric range and pass through the bottom plate 201, and then the flow direction of the hot air changes to both lateral directions of the electric range, at the channel part 701, and the hot air may be discharged outward through the third exhaust opening 703.

Air having flown into the air guide 600 may flow from the rear of the case 100 to the front of the case 100 along the air guide 600, the flow direction of the air may change at the second exhaust opening 610, and the air may flow in the downward direction of the electric range, pass through the second exhaust opening 610 and the first exhaust opening 220 consecutively and flow into the channel part 701. After the air flows into the channel part 701, the flow direction of the air may change again, and the air may move in both lateral directions of the case 100 along the channel part 701 and be discharged outward through the third exhaust opening 703.

Most of the air having flown into the channel part 701 may flow in both lateral directions of the electric range and be discharged outward through the third exhaust opening 703. Accordingly, hot air having passed through the first exhaust opening 220 and having escaped from the bracket 200 may be effectively blocked from flowing to the rear of the bracket 200 again.

Accordingly, the circulatory flow in which hot air flows to the rear of the bracket 200 and passes through the air blowing fan 500 and the air guide 600 again through the first suction opening 210 may be suppressed or prevented effectively. Thus, a stop of the operation of the electric range, which is caused by the heating of the heating element to a predetermine temperature or greater within a short period of time because of the circulatory flow of the hot air, may be suppressed or prevented, and operational performance of the electric range may be improved.

The air blowing fan 500 may be disposed at the rear part of the case 100, and the channel part 701 may be disposed at the front part of the case 100. Thus, hot air having flown into the channel part 701 may flow in both lateral directions of the electric range and be discharged outward at the channel part 701, and hot air may be effectively blocked from flowing into the air blowing fan 500 that is disposed further rearward than the channel part 701.

Referring to FIG. 17, among the guide panels 700, the first panel 710 and the second panel 720 at the front part of the electric range may be disposed in such a way that widthwise directions of the first panel 710 and the second panel 720 cross each other, to form a step 702. Outside the guide panel 700, the flow direction of air flowing to the first panel 710 and the second panel 720 may be changed by the step 702, and the air may flow to the outside of the case 100. That is, moisture, which is discharged from the upper portion of the door 11 of the dishwasher 10, and in the lower portion of the front of the electric range, flows to the guide panel 700, may be blocked by the step 702 formed by the first panel 710 and the second panel 720, and blocked from flowing into the electric range.

A portion of the moisture hitting the step 702 may flow reversely, another portion of the moisture may flow in both lateral directions of the electric range along the lengthwise direction of the step 702, and the other portion of the moisture may flow in the downward direction of the electric range, flow to the outside of the electric range, and finally be scattered in the atmosphere. With this embodiment, the step 702 formed by the first panel 710 and the second panel 720 may effectively block moisture from flowing into the electric range, thereby reducing the possibility of operational errors or failure of components in the electric range caused by the moisture, and ensuring significant improvement in the performance and durability of the electric range.

Referring to FIG. 17, the bottom plate 201 of the bracket 200, and the fifth panel 750 of the guide panel 700 may be spaced from each other in the upward-downward direction, as a height of the fifth panel 750 in the state of being coupled to the coupling part 120 of the case 100 differs from a height of the bottom plate 201 of the bracket 200. Accordingly, a portion of the hot air having flown into the channel part 701 may move to a separation space that is formed between the bottom plate 201 and the fifth panel 750 in the upward-downward direction, increasing the possibility of a circulatory flow.

To block generation of a partially circulatory flow described above, the above-described guide panel 700 may be provided with the sixth panel 760. However, to block the circulatory flow of hot air completely, the sixth panel 760 and the bottom plate 201 may be designed in such a way that an end of the sixth panel 760 and the lower surface of the bottom plate 201 contact each other.

In a case in which the sixth panel 760 and the bottom plate 201 contact each other, the sixth panel 760 and the bottom plate 201 may interfere with each other, making it difficult to maintain a structure in which the sixth panel 760 and/or the bottom plate 201 closely contact the case 100. Accordingly, the guide panel 700, the bracket 200, and other components may not remain flat, or may be twisted, in the electric range.

For this reason, the sixth panel 760 and the bottom plate 201 may be disposed in separate positions, such that the sixth panel 760 and the bottom plate 201 may not interfere with each other. For example, an upward-downward distance between the sixth panel 760 and the bottom plate 201 may be about 3.5 mm, by design.

However, in a case in which the sixth panel 760 and the bottom plate 201 are spaced from each other, some of the hot air having flown into the channel part 701 through the separation space may flow into the first suction opening 210, generating a circulatory flow. To solve this problem, the electric range according to an embodiment may further include a damper 900 that is disposed to fill the separation space between the sixth panel 760 and the bottom plate 201 and is made of a flexible material.

The damper 900 may have a shape corresponding to the shape of the sixth panel 760. Accordingly, the damper 900 may be provided in such a way a lengthwise direction of the damper 900 extends in both lateral directions of the electric range, to correspond to the sixth panel 760 that is disposed in such a way that the lengthwise direction of the sixth panel 760 extends in both lateral directions of the electric range.

The damper 900 may have a cross section that completely fills a separation distance between the sixth panel 760 and the bottom plate 201, and may have various shapes, such as a rectangle, a polygon, a circle, a semi-circle, an oval, and a star, for example. The damper 900 may adhere to the sixth panel 760 and/or the bottom plate 201 and be disposed between the sixth panel 760 and the bottom plate 201.

As the damper 900 is made of a flexible material, even in a case in which the damper 900 is disposed between the end of the sixth panel 760 and the lower surface of the bottom plate 201, the damper 900 may be easily deformed by an external force, and completely fill a space in which air may flow, without causing a change in positions of the sixth panel 760 and the bottom plate 201 and deformation of the sixth panel 760 and the bottom plate 201.

In this embodiment, the damper 900 may completely close the space, where air may flow, between the end of the sixth panel 760 of the guide panel 700 and the lower surface of the bottom plate 201, to effectively suppress or prevent the flow of hot air to the air blowing fan 500 from the channel part 701 through the space, thereby suppressing or preventing a circulatory flow of the hot air and ensuring improvement in the operational performance of the electric range.

Hereafter, results of an evaluation of simulation based on the above-described embodiment are described. The following particulars are based on results of simulation using a computer simulation program drawing an interpretation of the flow of fluids and a temperature distribution of fluids.

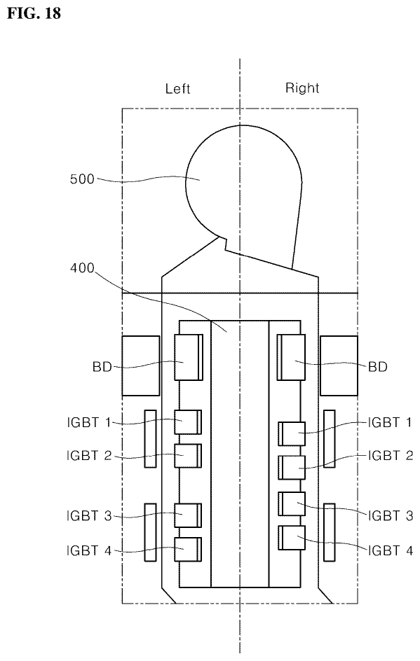

FIG. 18 is a view showing a heat sink for a simulation evaluation. For the simulation evaluation, heat sink 400 having a plurality of heat generating elements on an inclined surface of the upper portion thereof is embodied based on simulation.

The plurality of heat generating elements is disposed at a left or first lateral side and a right or second lateral side of the heat sink 400 symmetrically. For example, the heat generating element includes a total of two bridge diodes (BD), and a total of eight insulated gate bipolar transistors (IGBT).

Power consumption of each heat generating element is shown in table 1.

TABLE 1

| | BD | IGBT1 | IGBT2 | IGBT3 | IGBT4 |
|---|---|---|---|---|---|
| Left | 15.4 w | 15.7 w | 15.7 w | 18.5 w | 18.5 w |
| Right | 21.0 w | 12.0 w | 12.0 w | 12.0 w | 12.0 w |

The simulation conditions of cases 1 to 4 are described hereinafter.

Case 1: An electric range is without guide panel 700, and penetration hole 110 is open.

Case 2: An electric range is provided with guide panel 700, and penetration hole 110 and third exhaust opening 703 are open.

Case 3: An electric range is provided with guide panel 700, penetration hole 110 is closed, and third exhaust opening 703 is open.

Case 4: An electric range is provided with guide panel 700, and penetration hole 110 and third exhaust opening 703 are both closed.

As a result of simulation, an average temperature at the suction opening of air blowing fan 500 in each case is shown in table 2.

TABLE 2

| Case1 | Case2 | Case3 | Case4 |
|---|---|---|---|
| 63.5° C. | 56.6° C. | 59.2° C. | 62.3° C. |

As a result of simulation, an average temperature of each heat generating element mounted on heat sink 400, in each case, is shown in table 3.

TABLE 3
(° C.)

| | Left | | | | | Right | | | | |
|---|---|---|---|---|---|---|---|---|---|---|
| | BD | IGBT 1 | IGBT 2 | IGBT 3 | IGBT 4 | BD | IGBT 1 | IGBT 2 | IGBT 3 | IGBT 4 |
| Case1 | 148.0 | 183.7 | 187.7 | 201.3 | 203.1 | 153.9 | 170.2 | 175.0 | 176.7 | 178.0 |
| Case2 | 138.0 | 173.7 | 177.4 | 190.9 | 193.0 | 142.4 | 158.4 | 163.6 | 166.3 | 167.5 |
| Case3 | 140.2 | 175.9 | 179.6 | 193.1 | 195.2 | 144.6 | 160.6 | 166.0 | 168.6 | 169.8 |
| Case4 | 143.3 | 179.1 | 182.7 | 196.2 | 198.3 | 148.4 | 164.6 | 169.5 | 172.2 | 173.4 |

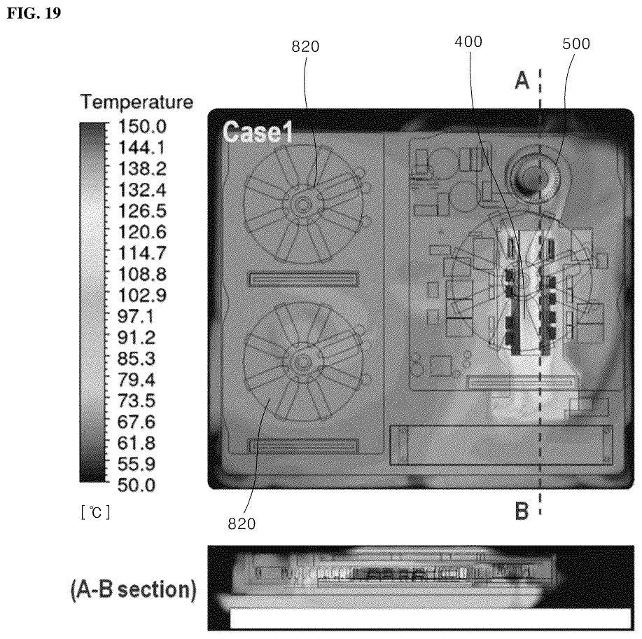

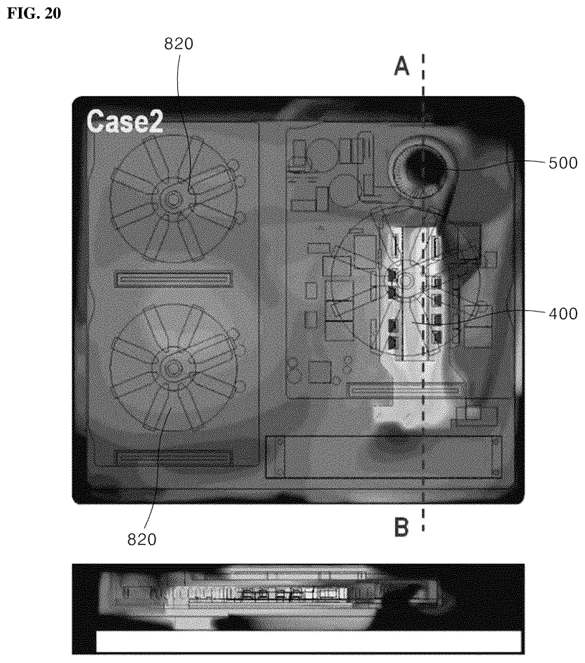

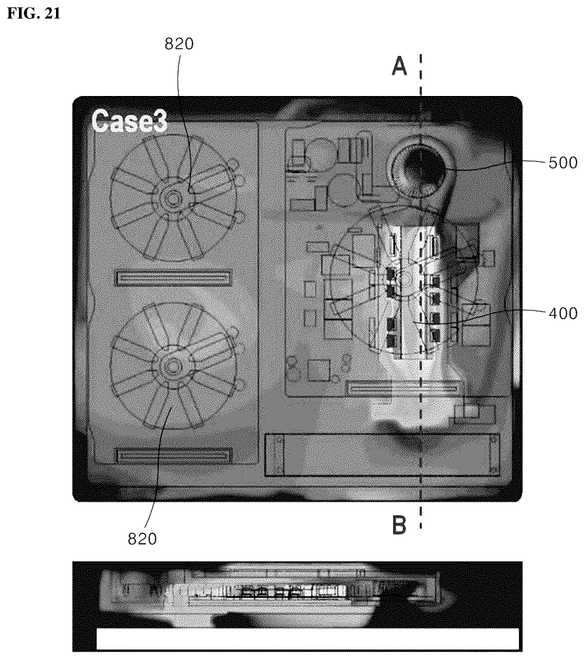

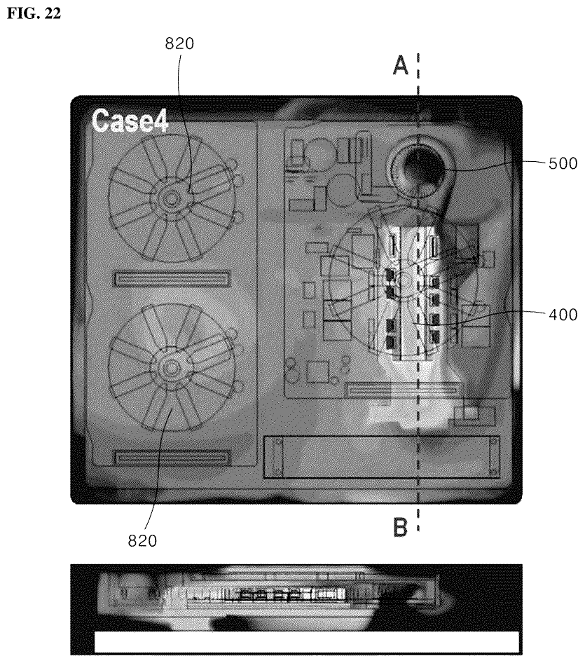

FIGS. 19 to 22 are views showing results of computer simulation-based evaluation of heat distribution of air flowing in an electric range according to an embodiment. FIGS. 19 to 22 respectively show an A-B cross-sectional view together with a plan view. The temperatures show average temperatures during simulation.

Referring to tables 2 and 3 and FIGS. 19 to 22, in cases 2 and 3 where an electric range is provided with guide panel 700 and third exhaust opening 703 is open, a temperature of the heat generating element is the lowest. Additionally, an average temperature of the heat generating element when the penetration hole 110 is open is lower than that of the heat generating element than when the penetration hole 110 is closed. Based on the results, the penetration hole 110 should be open for cooling.

As a result of simulation, in case 1 in which an electric range is not provided with guide panel 700, a temperature of the heat generating element is the highest. This clearly indicates that the guide panel 700 helps to reduce overheating of the heat generating element of the heat sink 400 effectively.

As shown in table 2, in case 1, an average temperature at the suction opening of the air blowing fan 500 is the highest, as a result of simulation. This suggests that the guide panel 700 provided with the channel part 701 blocks a circulatory flow of hot air.

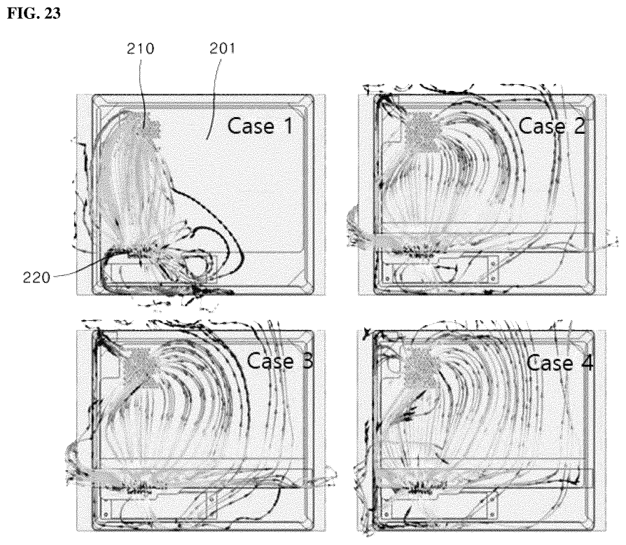

FIG. 23 is a view showing results of computer simulation-based evaluation of a flow tendency of air in an electric range according to an embodiment. FIG. 23 shows all the cases 1 to 4. FIG. 23 is a bottom view showing a bottom plate of the bracket viewed upward from below.

As illustrated in FIG. 23, in case 1 in which an electric range is without guide panel 700, the circulatory flow in which hot air discharged from first exhaust opening 220 flows into first suction opening 210 again occurs most actively.

In cases 2 and 3, hot air discharged from the first exhaust opening 220 flows along the channel part 701, flows in both lateral directions of the bracket 200 and is discharged smoothly out of the bracket 200 through the third exhaust opening 703. In case 4, the third exhaust opening 703 is closed, and hot air having flow into the channel part 701 is not discharged out of the bracket 200 immediately from the channel part 701. However, the circulatory flow of air in case 4 is reduced further than in case 1. In this embodiment, guide panel 700 having a relatively simple structure is disposed in the lower portion of the electric range, to block the circulatory flow of hot air as well as the inflow of external moisture, thereby effectively ensuring improvement in the operational performance and durability of the device.

Embodiments disclosed herein provide a dishwasher having structure that blocks moisture from flowing into the electric range through the lower portion of the electric range. Instead of a built-in electric range, a freestanding electric range, freely disposed in an open space on a supporter in the kitchen, may be provided with a leg that protrudes from the lower portion of the electric range to support the electric range. In the freestanding electric range, a space may be formed at the lower side of the electric range by the leg, and in a case in which the electric range is disposed on the dishwasher, moisture may flow into the space and flow into the electric range. In a case in which moisture discharged from the dishwasher flows into the electric range, the moisture may adversely affect components of the electric range. If the electric range is disposed near the dishwasher, structure blocking moisture from flowing into the electric range through the lower portion of the electric range is required.

Embodiments disclosed herein further provide a dishwasher having structure that blocks moisture, which flows into the lower space of the electric range formed by the leg of the electric range, from flowing into the electric range, in a case in which the freestanding electric range is disposed on the dishwasher.

Embodiments disclosed herein furthermore provide a dishwasher having structure that blocks hot air from circulating and flowing around a heat sink and reduces the possibility that a heat generating element is easily heated due to the hot air circulating and flowing.

Embodiments disclosed herein also provide a dishwasher having a guide panel that blocks the circulatory flow of hot air as well as the inflow of moisture.

Advantages are not limited to the above ones, and other aspects and advantages that are not mentioned above may be clearly understood from the description and may be more clearly understood from the embodiments set forth herein. Additionally, the aspects and advantages may be realized via means and combinations thereof that are described in the appended claims.

A electric range according to embodiments disclosed herein may include an air guide communicating with an air blowing fan, surrounding a heat sink and forming a flow path of air that cools the heat sink, and a guide panel being disposed at the lower side of a bracket and having a channel part, which guides a flow of air, in a position corresponding to an outlet of the air guide.

The channel part provided at the guide panel may guide air having escaped from the bracket to allow the air to flow in lateral directions of the electric range. Additionally, the channel part may effectively block hot air having escaped from the bracket from flowing to the rear of the bracket again.

The guide panel may include a first panel being elongated in the downward direction of a case, and a second panel bending from the end portion of the first panel and being coupled to the lower surface of the case. The first panel and the second panel may be disposed in such a way that the widthwise directions of the first panel and the second panel cross each other, to form a step. The flow direction of air flowing to the guide panel from the outside may be changed by the step, and the air may flow to the outside of the case. Accordingly, moisture from a dishwasher to the electric range may be blocked from flowing into the electric range by the guide panel. The guide panel having a relatively simple structure may be disposed in the lower portion of the electric range, to block the circulatory flow of hot air as well as the inflow of external moisture.

An electric range according to embodiments disclosed herein may include a case, a bracket being accommodated in the case, an air blowing fan being disposed in the bracket, a leg being coupled to a lower portion of the case, and being provided to contact an upper surface of a countertop that supports the electric range, and a guide panel being disposed at a lower side of the bracket, and guiding air that flows in a gap formed by the leg.

An electric range according to another embodiment may include a case, a bracket being accommodated in the case, a printed circuit board being disposed in the bracket, an air blowing fan being disposed in the bracket, a leg being coupled to a lower portion of the case, protruding further downward than a lower surface of the case, and being provided to contact an upper surface of a countertop that supports the electric range, and a guide panel being disposed at a lower side of the bracket, and guiding air that flows in a gap formed by the leg.

An electric range according to another embodiment may include a case, a bracket being accommodated in the case, a printed circuit board which is disposed in the bracket and in which a heat sink is disposed, an air blowing fan being disposed in the bracket, an air guide communicating with the air blowing fan and surrounding the heat sink, and a guide panel being disposed at a lower side of the bracket. The guide panel may have a channel part, guiding a flow of air, in a position corresponding to an outlet of the air guide.

An electric range according to yet another embodiment may include a case, a bracket being accommodated in the case, a leg being coupled to a lower portion of the case, and being provided to contact an upper surface of a countertop, and a guide panel being disposed at a lower side of the bracket, and guiding air that flows in a gap formed by the leg. The guide panel may include a first panel being elongated in a downward direction of the case, and a second panel bending from an end portion of the first panel, and being coupled to a lower surface of the case.

An air communication hole may be provided on a bottom plate of the bracket, and the guide panel may be disposed at a lower side of the air communication hole. The air communication hole may include a first suction opening allowing air to flow into an inlet of the air blowing fan, and a first exhaust opening allowing air having passed through the air blowing fan to be discharged, and the guide panel may be provided with a channel part guiding a flow of air, and the channel part may be disposed in a position where at least part of the channel part overlaps the first exhaust opening. The electric range may further include an air guide provided with a second exhaust opening that communicates with the air blowing fan, forms a flow path of air, and allows air to be discharged, and the channel part may be disposed in a position where at least part of the channel part overlaps the second exhaust opening.

A lengthwise direction of the channel part may be formed in both lateral directions of the case, and a third exhaust opening allowing air to be discharged may be formed at both ends of the channel part. Air having flown to the air guide may flow from a rear of the case to a front of the case along the air guide, flow into the channel part, flow in both lateral directions of the case along the channel part, and be discharged outward through the third exhaust opening.

The air blowing fan may be disposed at a rear part of the case. The channel part may be disposed at a front part of the case.

The guide panel may include a first panel being elongated in a downward direction of the case, and a second panel bending from an end portion of the first panel and being coupled to a lower surface of the case. The guide panel may have a channel part guiding a flow of air, and the guide panel may include a third panel bending from the first panel and forming a bottom surface of the channel part, a fourth panel bending from an end portion of the third panel and being spaced from the first panel, and a fifth panel being spaced from the second panel with the channel part between the fifth panel and the second panel, bending from an end portion of the fourth panel and being coupled to the lower surface of the case. Lengthwise directions of the first panel to the fifth panel may be placed in both lateral directions of the case.

The second panel may be disposed at a front of the channel part. The fifth panel may be disposed at a rear of the channel part.

The second panel may be elongated from the end portion of the first panel formed at a front of the channel part. The fifth panel may be elongated from the end portion of the fourth panel formed at a rear of the channel part.

The first panel and the fourth panel may be disposed in such a way that widthwise directions of the first panel and the fourth panel are parallel with an upward-downward direction of the case. The first panel and the second panel may be disposed in such a way that widthwise directions of the first panel and the second panel cross each other, to form a step, and a flow direction of air flowing to the first panel and the second panel, outside the guide panel, may be changed by the step, and the air may flow to the outside of the case. The guide panel further may include a sixth panel bending from an end portion of the fifth panel, and being disposed in a way that an end of the sixth panel faces a bottom plate of the bracket.

The electric range of one embodiment may further include a damper disposed to fill a separation space between the sixth panel and the bottom plate, and made of a flexible material.

In an electric range according to embodiments disclosed herein, most of the air having flown to the channel part may flow in both lateral directions of the electric range and be discharged outward through the third exhaust opening. Accordingly, hot air having passed through the first exhaust opening and having escaped from the bracket may be effectively blocked from flowing to the rear of the bracket again. Thus, a circulatory flow in which the hot air flows to the rear of the bracket again and passes through the air blowing fan and the air guide again through the first suction opening may be blocked effectively. As a result, a stop of the operation of the electric range, which is caused by the heating of a heating element to a predetermine temperature or greater within a short period of time because of the circulatory flow of the hot air, may be suppressed or prevented, and the operational performance of the electric range may be improved.

The step formed by the first panel and the second panel may effectively block the flow of moisture into the electric range, thereby reducing the possibility of operational errors or failure of components in the electric range caused by the moisture, and ensuring significant improvement in the performance and durability of the electric range. The damper may completely close the space, where air may flow, between the end of the sixth panel of the guide panel and the lower surface of the bottom plate, to effectively suppress or prevent the flow of hot air to the air blowing fan from the channel part through the space, thereby suppressing or preventing a circulatory flow of the hot air and ensuring improvement in the operational performance of the electric range.

The guide panel having a relatively simple structure may be disposed in the lower portion of the electric range, to block the circulatory flow of hot air as well as the inflow of external moisture and, thereby effectively ensuring improvement in the operational performance and durability of the device.

Embodiments are described above with reference to a number of illustrative embodiments thereof. However, embodiments are not limited to the embodiments and drawings set forth herein, and numerous other modifications and embodiments can be drawn by one skilled in the art within the technical scope. Further, the effects and predictable effects based on the configurations in the disclosure are to be included within the range of the disclosure, though not explicitly described in the description of the embodiments.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An electric range, comprising:
a case;
a bracket configured to be accommodated in the case;
a fan disposed in the bracket;
at least one leg coupled to a lower portion of the case and configured to contact an upper surface of a countertop that supports the electric range; and
a guide panel disposed at a lower side of the bracket and configured to guide air that flows into a gap formed by the at least one leg.

2. The electric range of claim 1, wherein at least one air communication hole is provided on a bottom plate of the bracket, and wherein the guide panel is disposed at a lower side of the at least one air communication hole.

3. The electric range of claim 2, wherein the at least one air communication hole comprises:
a first suction opening through which air flows to the fan; and
a first exhaust opening through which air having passed through the fan is discharged, wherein the guide panel is provided with a channel that guides a flow of the air, and wherein the channel is disposed in a position at which at least a portion of the channel overlaps the first exhaust opening.

4. The electric range of claim 3, wherein the electric range further comprises an air guide provided with a second exhaust opening that communicates with the fan, forms a flow path of air, and through which air is discharged, and wherein the channel is disposed at a position at which at least a portion of the channel overlaps the second exhaust opening.

5. The electric range of claim 4, wherein a lengthwise direction of the channel extends in both lateral directions of the case, and wherein a third exhaust opening that allows air to be discharged is formed at both ends of the channel.

6. The electric range of claim 5, wherein air having flown to the air guide flows from a rear of the case to a front of the case along the air guide, flows into the channel, flows in both lateral directions of the case along the channel, and is discharged outward through the third exhaust openings.

7. The electric range of claim 3, wherein the fan is disposed at a rear portion of the case, and wherein the channel is disposed at a front portion of the case.

8. The electric range of claim 1, wherein the guide panel comprises:
a first panel elongated in a downward direction of the case; and
a second panel bent from an end portion of the first panel and coupled to a lower surface of the case.

9. The electric range of claim 8, wherein the guide panel includes a channel that guides a flow of air, the guide panel comprising:
a third panel bent from the first panel and forming a bottom surface of the channel;
a fourth panel bent from an end portion of the third panel and spaced from the first panel; and
a fifth panel spaced from the second panel with the channel therebetween, bent from an end portion of the fourth panel, and coupled to the lower surface of the case.

10. The electric range of claim 9, wherein lengthwise directions of the first panel to the fifth panel extend in both lateral directions of the case.

11. The electric range of claim 9, wherein the second panel is disposed at a front of the channel, and wherein the fifth panel is disposed at a rear of the channel.

12. The electric range of claim 9, wherein the second panel is elongated from the end portion of the first panel formed at a front of the channel, and wherein the fifth panel is elongated from the end portion of the fourth panel formed at a rear of the channel.

13. The electric range of claim 9, wherein the first panel and the fourth panel are disposed in such a way that widthwise directions of the first panel and the fourth panel extend parallel to an upward-downward direction of the case.

14. The electric range of claim 13, wherein the first panel and the second panel are disposed in such a way that widthwise directions of the first panel and the second panel cross each other, to form a step, and a flow direction of air flowing to the first panel and the second panel, outside the guide panel, is changed by the step, and the air flows to the outside of the case.

15. The electric range of claim 9, wherein the guide panel further comprises a sixth panel bent from an end portion of the fifth panel and disposed in such a way that an end of the sixth panel faces a bottom plate of the bracket.

16. The electric range of claim 15, wherein the electric range further comprises a damper disposed to fill a separation space between the sixth panel and the bottom plate, and made of a flexible material.

17. An electric range, comprising:
a case;
a bracket configured to be accommodated in the case;
a fan disposed in the bracket;
at least one leg coupled to a lower portion of the case and configured to contact an upper surface of a countertop that supports the electric range; and
a guide panel disposed at a lower side of the bracket and configured to guide air that flows into a gap formed by the at least one leg, the guide panel including a channel that guides air from the electric range and discharges the air at lateral sides of the electric range.

18. The electric range of claim 17, wherein at least one air communication hole is provided on a bottom plate of the bracket, wherein the guide panel is disposed at a lower side of the at least one air communication hole, wherein the at least one air communication hole comprises:
a first suction opening through which air flows to the fan; and
a first exhaust opening through which air having passed through the fan is discharged, and wherein the channel is disposed in a position at which at least a portion of the channel overlaps the first exhaust opening.

19. The electric range of claim 18, wherein the electric range further comprises an air guide provided with a second exhaust opening that communicates with the fan, forms a flow path of air, and through which air is discharged, and wherein the channel is disposed at a position at which at least a portion of the channel overlaps the second exhaust opening.

20. The electric range of claim 19, wherein a lengthwise direction of the channel extends in both lateral directions of the case.
